(19) United States
(12) Patent Application Publication
(10) Pub. No.: US 2015/0002313 A1
(43) Pub. Date: Jan. 1, 2015

(54) METHOD TO MITIGATE HONKING OF VEHICLES

(71) Applicant: International Business Machines Corporation, Armonk, NY (US)

(72) Inventors: Sasha P. Caskey, New York, NY (US); Dimitri Kanevsky, Ossining, NY (US); Peter K. Malkin, Yorktown Heights, NY (US); Tara N. Sainath, New York, NY (US)

(73) Assignee: International Business Machines Corporation, Armonk, NY (US)

(21) Appl. No.: 13/960,421

(22) Filed: Aug. 6, 2013

Related U.S. Application Data
(63) Continuation of application No. 13/927,338, filed on Jun. 26, 2013.

(51) Int. Cl. G08G 1/0965

(52) U.S. Cl. CPC G08G 1/0965
USPC 340/902

(57) ABSTRACT

Mitigating honking, in one aspect, may comprise detecting an activation of a vehicle horn, generating a non-audible signal responsive to detecting the activation of the vehicle horn, and transmitting the non-audible signal to at least one recipient.

### CROSS-REFERENCE TO RELATED APPLICATIONS

This application is a continuation of U.S. Ser. No. 13/927,338, filed on Jun. 26, 2013, the entire content and disclosure of which is incorporated herein by reference.

### FIELD

The present application relates generally to automatically mitigating honking and/or honking noise produced, for example, in vehicles.

### BACKGROUND

Drivers honk their cars for a variety of reasons, for example, because of a slow moving car or stalled traffic ahead of them, to get the attention of another, or for other reasons. Inventors in the present disclosure have recognized that perhaps if a driver had knowledge of what is going on, for example, in the surrounding area that is causing the slow down or traffic stall, the driver might not need to honk as much. Furthermore, the inventors in the present disclosure have recognized that honking can be used to relay messages to other cars, for example, to speed up or move or another message, without producing the actual sound. Existing vehicular communications systems distribute information such as safety warning and traffic information, but from a central system.

### BRIEF SUMMARY

A method of mitigating honking may be provided. The method, in one aspect, may comprise detecting an activation of a horn of a vehicle. The method may also comprise generating a non-audible signal corresponding to sound that would result from the activation of the horn. The method may also comprise transmitting the non-audible signal to at least one targeted recipient device.

In another aspect, a method for notification of traffic information may be provided. The method, in one aspect, may comprise detecting a traffic situation requiring notification to one or more recipients responsive to receiving a non-audible signal corresponding to a honk of a vehicle. The method may also comprise identifying one or more recipients to be notified with a communication associated with the detected situation. The method may further comprise generating at least one directed, recipient-specific communication to at least one of the one or more recipients.

A system of mitigating honking, in one aspect, may comprise a processor and a module operable to execute on the processor, and further operable to detect an activation of a horn. The module may be further operable to generate a non-audible signal corresponding to sound that would result from the activation of the horn. A transmitter may be operable to transmit the non-audible signal to at least one targeted recipient device. In another aspect, the module may be operable to receive a non-audible signal generated by another device, and convert the non-audible signal into an audible honk.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a method of mitigating honking, e.g., of cars or other vehicles in one embodiment of the present disclosure.

FIG. 2 illustrates a method for notification of traffic information in one embodiment of the present disclosure.

FIG. 3 is a diagram illustrating components of a system for mitigating honking in one embodiment of the present disclosure.

FIG. 4 illustrates a schematic of an example computer or processing system that may implement the honking mitigating system in one embodiment of the present disclosure.

### DETAILED DESCRIPTION

In one embodiment of the present disclosure, a communication methodology between vehicles, e.g., cars, may be established such that drivers have knowledge of what is going on around them and thus may be able to reduce the number of times they honk their car horns.

In addition, honking may be implemented as to not produce an actual audible sound. In this way, a message may be relayed from a car to another in a quiet manner. For example, a car horn honking methodology may silence the actual sound, but still send a message, for example, to the car in front of or nearby the car generating the honking. Communication techniques such as wireless, cellular, radio, or usage of frequencies (e.g., ultrasound) may be utilized for communicating between the cars.

That message may be further relayed from the receiving car to another car, for example, the next car in front, and so on, until the message reaches a centrally universal system. For example, a central universal system could obtain this message via receivers located throughout the driving environment, e.g., augmenting existing traffic lights and/or at highway junctions. These receivers could receive honking messages from a car within their communicative distance or range and, in turn, could communicate directly to the central universal system. Communication may contain an identifier of the car that communicated to the receiver. Communication may be performed, e.g., via a mobile IP phone network. So for example, car honking may be silently transmitted to a sequence of cars and eventually to a central system.

In another aspect, a message may be relayed back to each car that honked. For example, the central system may detect based on information gathered, that the cars are not moving because of a traffic accident. The central system may send a message that provides that information, i.e., occurrence of the traffic accident. The central system, for example, may send the message to the car from which the central system received a honking message. Then, that car may relay the message back to another car, and so forth. In one embodiment, this message relay can be accomplished using the same communication method used by the initial honking. For example, the receivers used by the central universal system may also be equipped with honk generators that are enabled to broadcast or honk a message sent from the central universal system back to nearby cars. This would allow the central universal system to honk back information to cars.

In order for the central universal system to send a message back to particular cars, the honking messages may include the identifiers (IDs) of the one or more relevant target cars. In one embodiment of a method of the present disclosure, this may be accomplished by the honking messages including an ID for each relevant car (e.g., the car's unique vehicle identification number (VIN)). In one embodiment, it may be assumed that the relevant cars are still co-located when the central universal system sends its broadcast.

An embodiment of a method of the present disclosure may also support movement of the target cars. For instance, the central universal system may retrieve location information for each of the relevant cars, e.g., by receiving from each of these cars notifications as to their current location to the central universal system. The central universal system could then send out its broadcast to them via honk receiver/generators located nearby the relevant cars.

In another aspect, messages may be routed via the cars that keep track of the location of one another, e.g., relayed from car to car until they reach all of the necessary cars.

As another example, if it is a single car that is slowing down the traffic, that car may be identified via the relayed message, e.g., the car receives the honking message, whether directly or indirectly via one or more other cars, in which case the identified car may take an appropriate action, e.g., move to the side, change lanes, speed up, or another.

As yet another example, perhaps a user may want to relay a message to a car that his trunk is open or an item is hanging out of the car. He can speak the message into his car and have it relayed to a car around him. For instance, in one embodiment, the user's cars may be equipped with a speech-to-honk translator, which takes a verbal input, and then converts it to a non-audible honking sequence (e.g., an encoding of the spoken message, or a commonly agreed upon sequence) which represents the message. Once calculated, the speech-to-honk translator may send the encoded message to the recipient car. A device of the recipient car receives this message and may translate it back to an audible message.

A methodology in one embodiment of the present disclosure allows directing car horn honks to a selected set of objects and or people. For example, honks may be directed to one or more particular cars (other vehicles) or particular devices, such that only people in or near those cars or devices may hear the honks. As another example, whether a car is located in a honking forbidden zone or area may be detected, and if so, honking can be sent silently to other cars in that area. For instance, rather than producing sounds in response to a user honking a car horn, a signal may be sent through an available network, e.g., WIFI, cellular, radio, or usage of frequencies (e.g., ultrasound) which cannot be heard by a human, which would then be amplified or transformed by the receiving machine, for example, the receiving car.

In another aspect, honk may be sent to only people in situations where the people are the target of the alert, for example, by using an available network or using non-human frequencies which will be amplified by the devices carried on the humans. The honking message can also be sent through a directed light impulse allowing for accurate targeting, the light impulses may then be transformed into a message. The honking message may be sent through other signal mediums.

Yet in another aspect, honks may be sent to all available devices within a certain geographical boundary (e.g., cellphones, computers, watches). When the intended target does not contain a device which supports receiving the messages (e.g., devices unequipped to receive silent honks or ones unable to decode audible ones), messages may be sent to devices near the intended target. Honks may be sent to one or more devices close to or near the intended target when the intended target does not contain a honkable device.

Still yet in another aspect, messages may be encoded through honking. For example, messages can be sent using the horn to express amusement, entertainment, courtship, encouragement, and/or another emotion or expression. The horn may be used to communicate messages to nearby vehicles or persons. The messages can be used to express support for an idea or bumper sticker, to imply interest in friendship, or to inform of traffic up ahead, e.g., as the reason for a slow down. In one embodiment, a message may be encoded using combination of honks, e.g., combinations for short and long honks along with breaks (e.g., short, rest, short, short, short, long, long, rest, long, long), similar to Morse code mechanism.

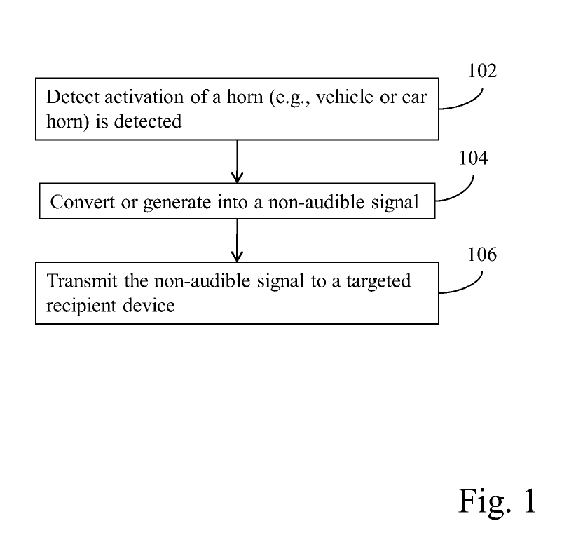

FIG. 1 illustrates a method of mitigating honking of cars in one embodiment of the present disclosure. While the description uses “cars” as examples, it should be understood that the methodologies of the present disclosure may apply to any vehicles or other devices/equipments that might use honking. At 102, an activation of a car horn is detected. For example, a honk generator or device may be equipped with an activation mechanism such as a button or another such interface for allowing a driver to press or activate to sound a horn.

At 104, sound that would result from the activation of the car horn may be converted or generated into a non-audible signal. For example, the honk generator or device may in response to the activation of the horn, convert the honk sound before it is sounded, into a non-audible signal. Hence, instead of a sound, a non-audible message corresponding to the honking sound is output. In one embodiment, whether to sound audibly or to transmit as a non-audible signal may be configured based on one or more criteria, and conversion or generation into a non-audible signal may occur automatically based on a criterion such as the current location of the car.

At 106, the non-audible signal is transmitted to a targeted recipient device, wherein only the targeted recipient device is alerted of the non-audible signal. In this way, other cars or people around the area of the honking car do not hear the noise of the honk.

In one embodiment, the non-audible signal may be transformed into a honk sound in the targeted recipient's device. Examples of the targeted recipient device may comprise one or more vehicles, or one or more devices carried by a pedestrian, for example, near the area of the vehicle or device originating the honk.

A central universal system may receive the honking message routed via one or more other vehicles and/or a receiver installed at geographic locations. The central universal system may assess and determine what is happening in the area of the originating honk, and relay the assessed information back to the device originating the honk, e.g., via the one or more other vehicles and/or the receiver installed at geographic locations. The information, for instance, may include traffic information or other information.

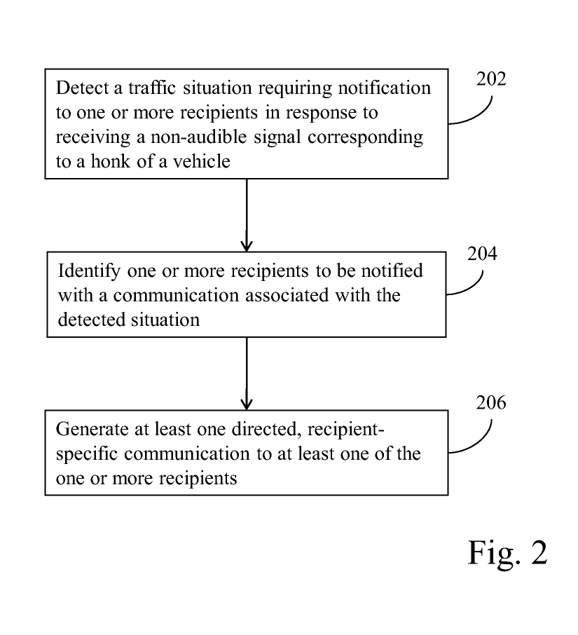

FIG. 2 illustrates a method for notification of traffic information in one embodiment of the present disclosure. For instance, at 202, the central universal system may detect a traffic situation requiring notification to one or more recipients, responsive to receiving a non-audible signal corresponding to a honk of a vehicle. At 204, the central universal system may also identify one or more recipients to be notified with a communication associated with the detected situation. At 206, the central universal system may generate at least one directed, recipient-specific communication to at least one of the one or more recipients. The recipient may comprise one or more of a driver, a pedestrian, a bicycle, a vehicle on-dash display, a vehicle horn, or a vehicle audio device, a vehicle haptic notification device, or another device associated with a vehicle or a recipient, or combinations thereof. The directed communication may be broadcast or transmitted to a plurality of recipients.

In one aspect, the identifying one or more recipients comprises a user (e.g., one who would be honking) inputting selected recipients. Inputting selected recipients may also comprise directing a camera toward an intended recipient. For example, the user could have an application running on their smart phone which would enable them to employ the phone's camera to identify the recipient of a given silent honk by taking the intended recipient's photo. The phone app would use the camera's location, orientation, and focus to determine the exact geospatial location of the recipient. This information could then be used to direct the silent honk.

The communication associated with the detected situation may comprise one or more of a honking sound heard only inside a recipient's vehicle, a honking sound heard only by one or more pedestrians, a honking sound heard only by a selected set of recipients comprising one or more of cars, pedestrians, or combinations thereof. Multiple pieces of information may also comprise multiple pieces of information, e.g., to convey different meanings. The communication associated with the detected situation may be sent via at least one of wireless, radio, audio, and light communication mode. In another aspect, the communication associated with the detected situation may be sent to people-wearable devices.

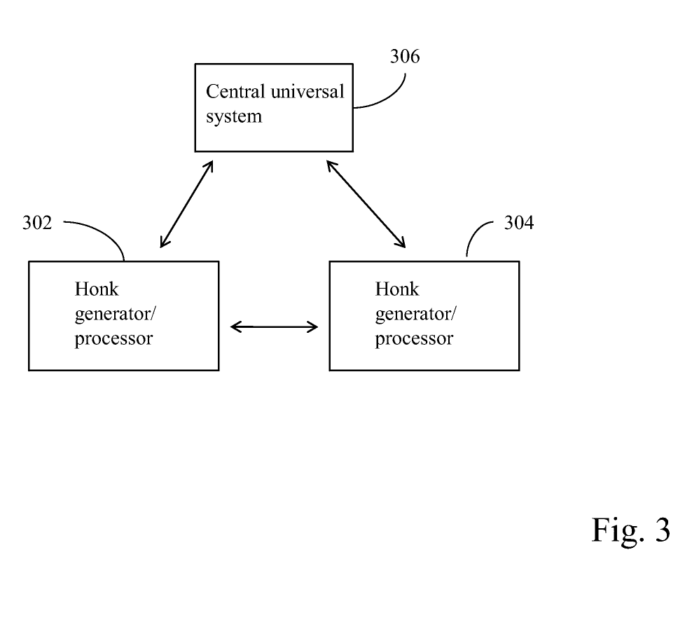

FIG. 3 is a diagram illustrating components of a system for mitigating honking in one embodiment of the present disclosure. A honk generator device 302 may be installed or carried in a vehicle or on a person, and may generate non-audible honks to be transmitted to one or more recipients as described above. The honk generator device 302 may comprise a computer hardware processor. The honk generator device 302 may generate a non-audible honk in the form of a wireless signal (e.g., radio frequency) in response to receiving an input from a user, e.g., mechanical actuation of a honk by push of a button. The generated signal may be transmitted to another honk generator device 302, where it may be received and processed. The generated signal may be also transmitted to a central universal system 306, for processing as described above.

The honk generator device 302 may also function as a message relay, wherein non-audible honk signals received may be relayed to another honk generator device 304 (e.g., carried by another vehicle or person) or a central universal system 306. A message format, for instance, may indicate that a recipient of a message is to relay the message to another recipient, for instance, by an indication such as a relay tag in the message header or the like.

The honk generator device 302 may also function to convert a non-audible honk received from another device 304 or a central universal system 306, into an audible honk or audible speech for the recipient to hear.

As a person of ordinary skill in the art would understand, the non-audible honk signals may be described in a structured format, comprising for example, message headers that might convey information such as the message type (e.g., honk, recipient identity, a relay indicator, and other information for transmitting a message to one or more target recipients) and message payloads that conveys the content of the message. Other formats may be utilized and other information may be included.

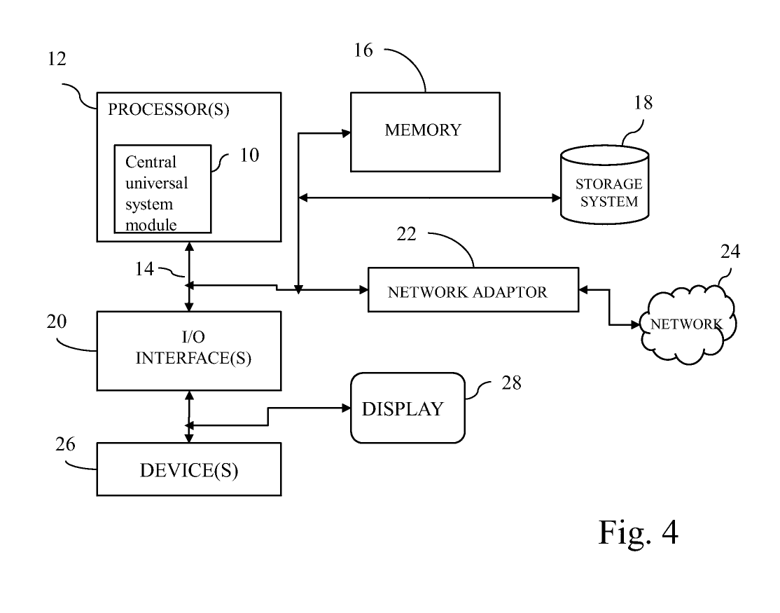

FIG. 4 illustrates a schematic of an example computer or processing system that may implement the car honking mitigation system in one embodiment of the present disclosure. For instance, the central universal system (e.g., shown in FIG. 3 at 306) may be implemented on such computer system. The honk generator device (e.g., shown in FIGS. 3 at 302 and 304) may also comprise similar hardware components described below, such as hardware processor(s), memory, bus and other components as need to perform its functionality. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer readable storage medium storing a program of instructions executable by a machine to perform a method of mitigating honking, comprising:
detecting an activation of a horn of a vehicle;
generating a non-audible signal in response to the activation of the horn, the non-audible signal corresponding to sound that would result from the activation of the horn; and
transmitting the non-audible signal to at least one targeted recipient device.

2. The computer readable storage medium of claim 1, wherein the sound that would result from the activation of the horn is suppressed and generated into the non-audible signal.

3. The computer readable storage medium of claim 1, wherein the non-audible signal is transformed into a honk sound in the targeted recipient's device.

4. The computer readable storage medium of claim 1, wherein the sound is converted into one or more different non-audible signals carrying one or more different type of information.

5. A system of mitigating honking, comprising:
a processor;
a module operable to execute on the processor, and further operable to detect an activation of a horn, the module further operable to generate a non-audible signal in response to the activation of the horn, the non-audible signal corresponding to sound that would result from the activation of the horn; and
a transmitter operable to transmit the non-audible signal to at least one targeted recipient device.
